(19) United States
(12) Patent Application Publication
(10) Pub. No.: US 2005/0197110 A1
(43) Pub. Date: Sep. 8, 2005

(54) Method and apparatus for enhanced directory assistance in wireless networks

(75) Inventors: Peggy Hasan, Aurora, IL (US); Sandra Lynn True, St. Charles, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/795,569

(22) Filed: Mar. 8, 2004

(51) Int. Cl. H04M 1/64; H04M 11/10

(52) U.S. Cl. 455/417; 455/413

(57) ABSTRACT

A method of providing directory assistance to a caller having a mobile station in a wireless network is provided. The method includes receiving a request for directory assistance information from the caller, obtaining directory assistance information from a database, giving a set of delivery options for the directory assistance information to the caller, and determining whether the caller has chosen one or more delivery options from the set of options. Where the caller has chosen at least one delivery option, the directory assistance information is sent to the caller via the delivery option or options chosen by the caller. Where the caller has not chosen at least one delivery option, the directory assistance information is sent to the caller via a default delivery option.

### BACKGROUND OF THE INVENTION

This invention relates generally to the art of telecommunications, and, more particularly, to a method and apparatus for enhanced directory assistance in wireless networks.

By way of background, directory assistance is a service offered by local exchange carriers that provides a customer with a requested telephone number for another party. The customer may supply a name and a city location of the subject party to the directory assistance operator. The operator then looks up that party's telephone number in a computer database and provides the telephone number to the customer. Often, the operator, upon locating the telephone number, activates a pre-recorded voice announcement to convey the telephone number to the customer. Some directory service providers further offer to connect the customer to the telephone number for a predetermined fee.

While satisfactory for most customers, this arrangement is ill-suited for many mobile (or wireless) telephone customers. For example, such customers are usually away from their general home or work environments (e.g., in a vehicle), and thus may not have ready access to a pen and paper in order to make a note of the desired number. Even if such materials are available, the customer may not find it convenient to interrupt other activities, e.g., driving, in order to make a note. In addition, the process of initiating a second call, this time to the desired party, entails further manual operations (e.g., hanging up, waiting for another dial tone, and dialing) that may be a hindrance to the customer's other activities.

The present invention contemplates a new and improved method and apparatus for enhanced directory assistance in wireless networks that resolves the above-referenced difficulties and others.

### SUMMARY OF THE INVENTION

A method and apparatus for enhanced directory assistance in wireless networks are provided.

In one aspect of the invention, a method of providing directory assistance to a caller having a mobile station in a wireless network is provided. The method includes receiving a request for directory assistance information from the caller, obtaining directory assistance information from a database, giving a set of delivery options for the directory assistance information to the caller, and determining whether the caller has chosen one or more delivery options from the set of options. Where the caller has chosen at least one delivery option, the directory assistance information is sent to the caller via the delivery option or options chosen by the caller. Where the caller has not chosen at least one delivery option, the directory assistance information is sent to the caller via a default delivery option.

In another aspect of the invention, an apparatus for providing directory assistance to a caller having a mobile station in a wireless network is provided. The apparatus includes means for receiving a request for directory assistance information from the caller, means for obtaining directory assistance information from a database, means for giving a set of delivery options for the directory assistance information to the caller, and means for determining whether the caller has chosen one or more delivery options from the set of options, means for sending the directory assistance information to the caller via the delivery option or options chosen by the caller, where the caller has chosen at least one delivery option, and means for sending the directory assistance information to the caller via a default delivery option, where the caller has not chosen at least one delivery option.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings.

FIG. 1 is a block diagram of a telecommunications environment suitable for implementing aspects of the present invention.

FIG. 2 is a block diagram of the mobile switching center according to an aspect of the present invention.

FIG. 3 is a block diagram of the voicemail system according to an aspect of the present invention.

FIG. 4 is an overall flow chart describing an algorithm for implementing aspects of the present invention.

FIG. 5 is a call flow diagram illustrating an embodiment of the enhanced directory assistance method.

### DETAILED DESCRIPTION OF THE PREFERRED EMBODIMENTS

It is to be understood that the specific method and apparatus illustrated in the attached drawings and described in the following specification are simply embodiments of the inventive concepts defined in the appended claims. Therefore, specific examples and characteristics related to the embodiments disclosed herein are not to be considered as limiting, unless the claims expressly state otherwise.

The present invention allows the network to provide support for additional options for delivery of directory assistance information to a caller using mobile communication device, such as a mobile phone. In particular, the caller will have the option of requesting that an SMS message be sent to his or her mobile phone, where the message contains the name and phone number of the party requested. Secondly, the caller will have the option of receiving a voicemail message that will have an audio representation of the name and phone number requested. Thirdly, the caller may choose to have an entry automatically delivered to the phone book of the mobile phone, which will store the name and phone number of the party requested. Finally, the caller can choose to have an entry sent to the mobile phone to be stored in the “last numbers dialed list.” This option could be used for a number which the caller may need on a temporary basis.

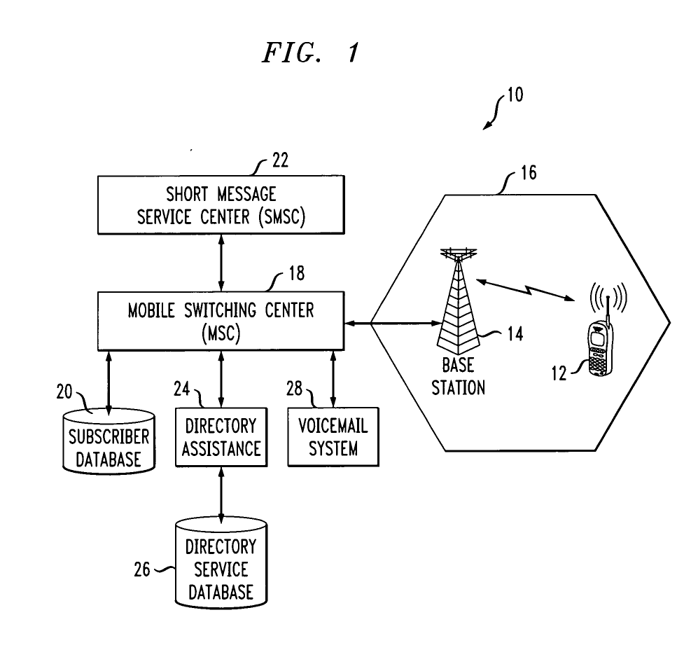

FIG. 1 is a functional block diagram of a basic wireless communication network 10 to illustrate an example of an operating environment of the present invention. A mobile station 12 for permitting voice communication and which may be compatible with short message service (SMS) is shown as being in wireless communication with the network 10. The mobile station 12 generally comprises a control unit and a transceiver that transmits and receives radio transmissions to and from a cell site. The mobile station 12 may be of any type compatible with or employing short length text messaging, including mobile telephones, networked personal computers, handheld computing or digital devices, or any other such device.

Voice calls and text messages are conveyed to the mobile phone 12 via the network 10. The network 10 includes any number of wireless transceiver stations 14 that correspond to a communication cell 16, and the network 10 may include one or more cells 16. The mobile phone 12 within the cell 16 communicates with the network 10 via a wireless link with the appropriate transceiver station 14 as known in the art. The transceiver station 14 communicates with a mobile switching center (MSC) 18 that directs communications between the mobile phone 12 and various communication channels.

The MSC 18 is essentially a switching element that routes calls and performs call handling functions. Although only one MSC 18 is shown in the figure, it is understood that the network 10 may include multiple MSCs that are spaced geographically apart. The MSC 18 routes calls by accessing information in a subscriber database, such as a home location register (HLR) 20. It should also be understood that switching elements of different types may be used in networks that vary from the example network 10.

The subscriber database 20 is generally a functional database containing subscriber profile and mobility management information. The subscriber database 20 typically maintains subscriber information such as subscription information, location information, and directory assistance delivery information. Subscription information relates to the services that each subscriber is authorized to use. The subscriber database 20 uses the subscription information to verify that the subscriber is authorized for prepaid wireless service, for example. One type of location information is the last MSC 18 that was registered as serving the subscriber. This is stored in the form of a mobile switching center identification number, which identifies the appropriate MSC. Other location information is used to calculate tax on the cost of a call. In addition, the subscriber is identified using a mobile identification number. Location information is used to properly route and bill the call. Directory assistance delivery information relates to a subscriber's choice (or choices) of delivery methods for enhanced directory assistance in accordance with aspects of the present invention.

The network 10 supports a short text message service by which short text messages, in some cases of up to a maximum length, may be transmitted or received by mobile stations, such as the mobile phone 12. As an example, the short text message service could include or conform to the SMS standard that is part of the GSM Phase 1 standard, or any other wireless communication SMS standard. One SMS standard allows transmission of fixed length text messages of up to about 160 characters in length.

In this regard, the network 10 includes at least one short message service center (SMSC) 22 that is in networked communication with the MSC 18. The SMSC 22 generally functions to direct short text messages to and from the mobile phone 12. The SMSC 22 is defined in IS-41. The MSC 18 and the SMSC 22 may be located together or may be remote from each other, as is known in the art.

The network 10 further includes a directory assistance service center 24 and a corresponding directory service database 26. The directory service database 26 provides operators with the means to search for a customer's desired party, and determine the appropriate telephone number. In the preferred embodiment, the directory service database 26 provides the capability to search not just by name and address, but also by type of goods/services and/or geographical region. For example, the database may answer queries soliciting the names/numbers of shops carrying office equipment in Chicago, Ill., or of Chinese restaurants on a given street. The database software itself is conventional. The presently preferred best mode is to use a relational database, such as is available from Oracle. However, much simpler software can alternatively be used, such as DBase 4.

The network 10 further includes a voicemail system 28, which allows callers to leave recorded messages for called parties when the called parties are unavailable. The voicemail system 28 records messages if the called party's phone line is either in use or does not answer. The voicemail system 28 may also record messages from the service provider. In either case, the voicemail system 28 answers the phone call and records the message. Typically, the message is digitized and stored on a computer hard disk for later playback by the called party. To play recorded messages, a mailbox owner calls the voicemail system 28 and accesses stored voice messages using a sequence of touchtone or voice commands. In response to these commands, the voicemail system 28 can perform various functions with respect to message playback.

It will be appreciated that certain components of the network 10, such as the MSC 18, the subscriber database 20, the SMSC 22, the directory assistance service center 24, the directory service database 26, the voicemail system 28 may each be implemented with one or more specialized or general purpose computer systems. Such systems commonly include a high speed processing unit (CPU) in conjunction with a memory system (with volatile and/or non-volatile memory), an input device, and an output device, all as known in the art.

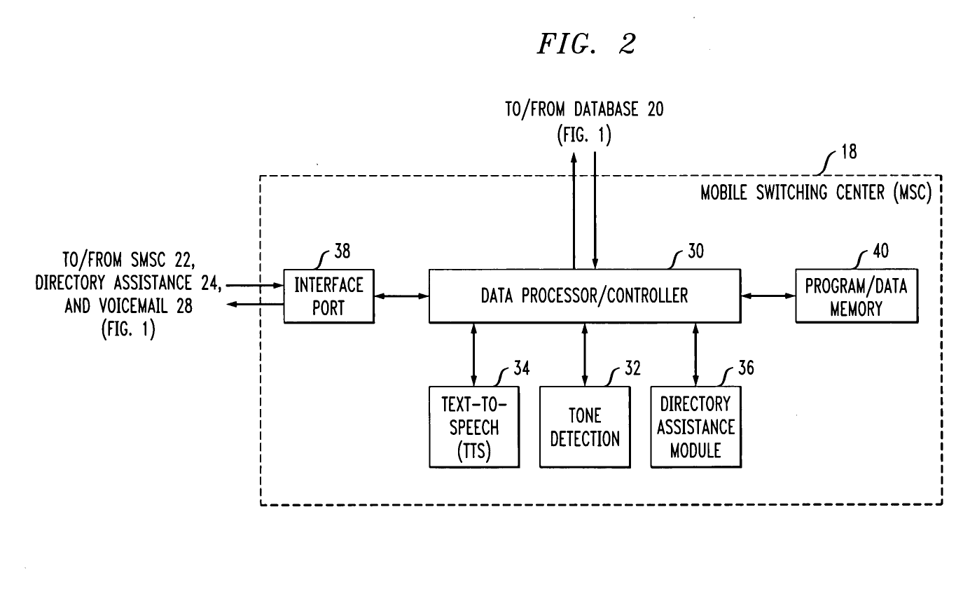

The elements of the network 10 described thus far are generally standard in the industry, and their operation is well known in the art. The present invention comprises an improvement to the communication network 10 of the type shown in the drawings. The improvement includes making certain modifications to the function of the MSC 18 as shown in FIG. 2. Thus, the MSC 18 may comprise several components, including a data processor/controller 30 for processing information, tone detection circuitry 32 for recognizing dialed multi-frequency tone signals indicative of well known telephone dialing keypads of numerals or groups of three alphabetic letters, a conventional text-to-speech (TTS) system 34, and a directory assistance module 36.

In accordance with the present invention, the directory assistance module 36 is responsible for checking the subscriber database 20 to determine whether a caller has subscribed to enhanced directory assistance service and whether the feature is active. Additionally, the directory assistance module 36 accesses the subscriber database 20 to determine the subscriber preferences, if any, for the enhanced directory assistance service. The directory assistance module 36 also directs how the directory assistance information will be presented to the caller/subscriber.

Data input is generally received from the network 10 (i.e., the SMSC 22, the directory assistance service center 24, and/or the voicemail system 28) at the interface port 38 and then transmitted to the data processor/controller 30. The processor 30 may also receive data input from the tone detection circuits 32, the TTS system 34, and/or the directory assistance module 36. Programs and temporary memory for implementing enhanced directory assistance service is shown as program/data memory 40, which is connected to the processor 30.

The MSC 18 may receive text corresponding to a telephone number from the directory assistance service center 24. The text is received at the directory assistance module 38, and it is then forwarded to the TTS system 36. The text-to-speech conversion process is generally known to those skilled in the art. For example, the TTS system 34 would analyze the text and generates a synthesized speech signal that may be transmitted to an acoustic output device, such as the mobile phone 12, and/or to the voicemail system 28. The acoustic output device (or the mobile phone 12) would then output the synthesized speech signal to the caller. There are many types of software systems known in the art that reliably convert text to speech. A few examples of such software include: Hal Screen Reader for Windows, Cicero Text Reader, outSPOKEN 9.0 & 9.2 for Macintosh, and ALVA Braille Terminal 320.

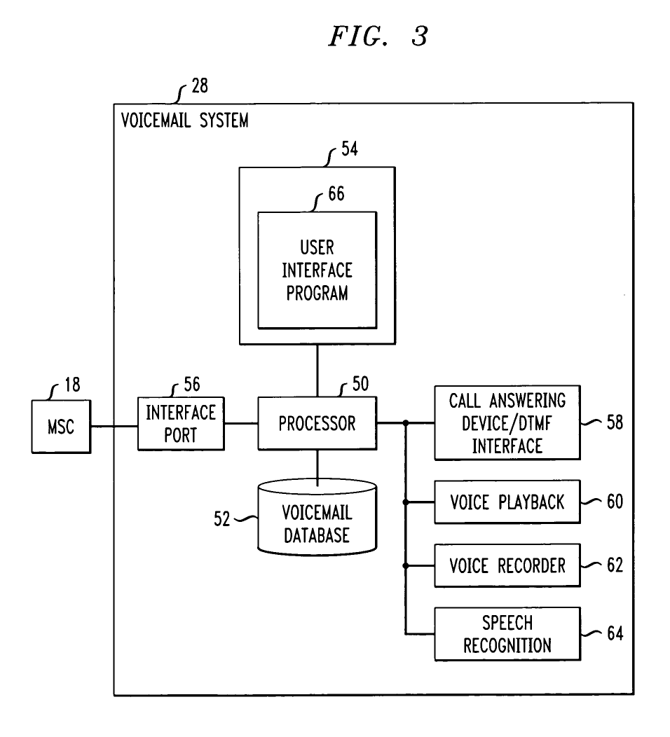

FIG. 3 is a block diagram showing the components of the voicemail system 28, which is conventional and known to those skilled in the art. The voicemail system 28 can be a voicemail server communicating with the MSC 18 over a standard interface. The voicemail system 28 includes a processor 50, voicemail database (DB) 52 for storing voicemail messages, a memory 54, and interface port 56, a call answering device/dual-tone multi frequency (DTMF) interface 58, a voice playback subsystem 60, a voice recorder 62, and a speech recognition subsystem 64. The memory 54 can store a user interface program 66 that is executable by the processor 50. The voicemail system 28 can be implemented using a Compact Service Node, available from Lucent Technologies, Inc., configured and programmed to perform the functions disclosed herein.

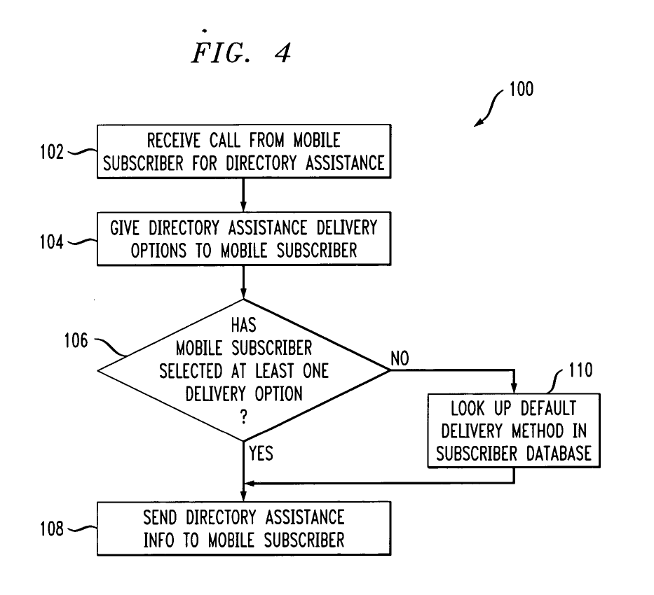

In operation, the present invention allows the network 10 to provide support for additional options for delivery of directory assistance information to a caller using a mobile communication device. Turning now to FIG. 4, there is illustrated a flow chart 100 depicting a method of providing enhanced directory assistance service to wireless customers in accordance with an embodiment of the present invention. The method is preferably implemented through software that is distributed throughout the network 10 as described below.

Directory assistance is provided by the directory assistance service center 24. The directory assistance service center 24 is preferably automated and implemented through automated prompting and speech recognition systems known in the art. Thus, initially, a caller may dial a number such as 411, and the call will be connected to the directory assistance service center 24 in the usual manner (step 102).

The MSC 18 is enabled to present voice prompts to callers through the TTS system 34 upon receipt of information from the directory assistance center 24 to the directory assistance module 36. Thus, the caller may receive a pre-recorded prompt from the MSC 18 such as “Directory assistance: For what city please.” Then, once the city is voiced, there is a prompt: “For what listing.” And, in response to the prompt and depending on the response the caller gives, a live operator need not intervene in the call. The directory assistance service center 24 looks up the telephone number in the database 26. The desired telephone number is announced through a speech synthesized announcement through the TTS system 34. Moreover, the call may be completed to that number without redialing according to a known service offering.

In accordance with the present invention, the caller is then offered several options for delivery of the directory assistance information—i.e., the telephone number (step 104). Alternatively, the system may be set up so that these options are presented to the caller only after the MSC 18, through the directory assistance module 26, checks the subscriber database 20 to determine whether the enhanced directory assistance feature has been subscribed to and is active for the caller.

The delivery options include, but are not limited to: (1) receiving a short text message that includes the telephone number; (2) receiving a voicemail message that includes the phone number; (3) having the information sent directly to the phone book of the mobile phone 12; and (4) having the information sent as an entry to the “last numbers dialed” (or “outgoing messages”) list of the mobile phone 12.

Thus, for example, the MSC 18 may state the voice prompt, “The number is (312) 555-1111. For further options, push or say 9.” If the caller selects 9, either by pushing the digit on the keypad or by saying the number, then the MSC 18 may state the voice prompts: “If you would like to receive a short text message, press or say 1. If you would like to receive a voicemail message, press or say 2. If you would like to receive a phone book entry, press or say 3. If you would like to update your last numbers dialed list, press or say 4.” The MSC 18 is enabled to determine the selection by using well known dual tone multi frequency (DTMF) recognition and/or voice recognition. Speech recognition enhances the method by simplifying the caller interface. However, is not mandatory to deliver the key benefits of the method. If speech recognition is too expensive or complex, a simpler menu driven interface can replace it.

Next, the directory assistance service center 24 determines in the usual manner whether the caller has selected at least one delivery option by entering a digit (or digits) via the keypad of the mobile phone 12 (or by announcing the selection) (step 106). If so, then the directory assistance information is sent to the caller in the format(s) requested (step 108).

Otherwise, the directory assistance center 24 looks up the default delivery option (or options) for the caller in the database 26 (step 110). The default delivery option(s) may have been pre-selected by the caller or selected by the service provider. In either case, the directory assistance information is sent to the caller in the format(s) requested.

To send an SMS message to the mobile phone 12, the MSC 18 instructs the SMSC 22 to transmit a text message containing the directory name and phone number requested to the mobile phone 12.

To send a voicemail message to the caller's voicemail, the MSC 18 establishes a connection to the originating mobile's voicemail system 28 mailbox and leaves a voice recording from directory assistance 24 containing the directory name and phone number requested.

To update the phone book of the mobile phone 12, the MSC 18 sends a message to the mobile phone 12 with instructions to add the attached directory name and phone number to the mobile phone's local phonebook.

To update the last number dialed list of the mobile phone 12, the MSC 18 sends a message to the mobile phone 12 with instructions to add the attached directory number to the last number dialed list on the mobile phone 12.

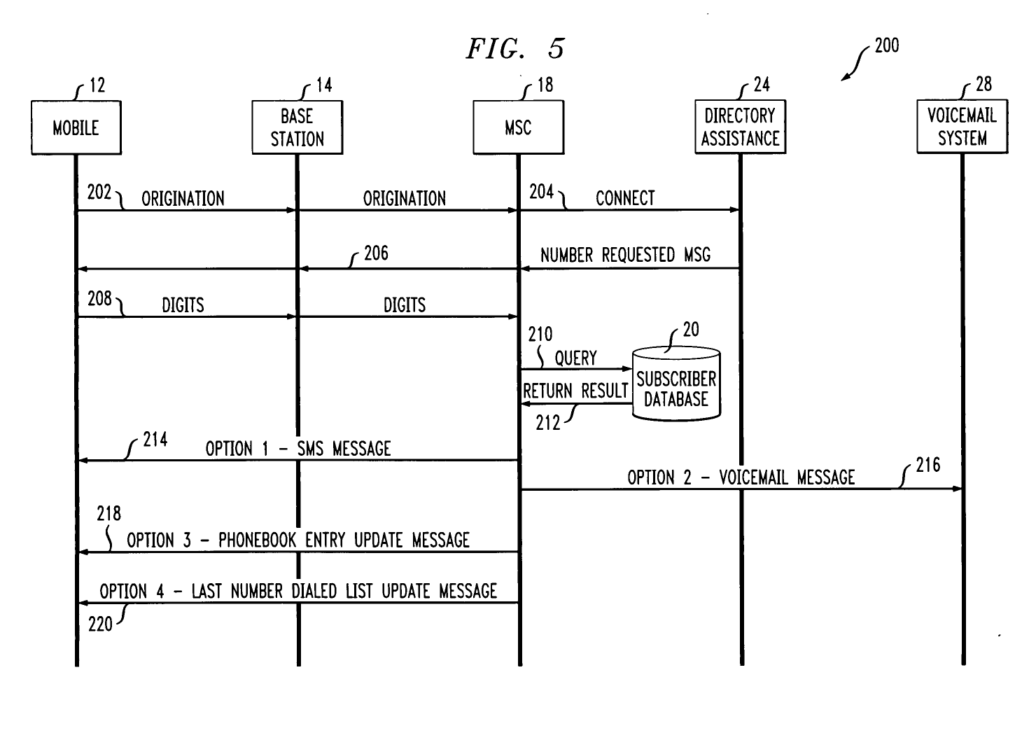

FIG. 5 is a call flow diagram 200 in accordance with the enhanced directory assistance method of the present invention. Initially, a call origination message is forwarded from the mobile phone 12 to the MSC 18 through the base station 14 (202). The MSC 18 then sends a connect message to the directory assistance center 24 (204). The directory assistance center 24 sends a number requested message to the mobile phone 12 through the MSC 18 and the base station 14 (206). The caller enters his or her choice(s) of delivery options via the keypad and the digits are sent to the MSC 18 through the base station 14 (208).

If no delivery option is chosen by the caller, then the MSC 18 queries the subscriber database 20 for the default delivery option (210). The result is then sent to the MSC 18 (212). If option 1 has been selected, then an SMS message is sent to the mobile station 12 (214). If option 2 has been selected, then a voicemail message is sent from the MSC 18 to the mobile station 12 (216). If option 3 has been selected, then a phone book entry update message is sent from the MSC 18 to the mobile phone 12 (218). If option 4 has been selected, then a last numbers dialed list update message is sent from the MSC 18 to the mobile phone 12 (220).

Thus, there has been shown and described a method and apparatus for enhanced directory assistance service in wireless networks. The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. In a wireless communication network, a method of providing directory assistance to a caller using a mobile station, the method comprising:
receiving a request for directory assistance from the caller;
obtaining directory assistance information from a database;
giving a set of delivery options for the directory assistance information to the caller;
determining whether the caller has chosen one or more delivery options from the set of delivery options;
where the caller has chosen at least one delivery option, sending the directory assistance information to the caller via the at least one delivery option chosen by the caller; and
where the caller has not chosen at least one delivery option, looking up a default delivery option for the caller in a database and sending the directory assistance information to the caller via the default delivery option.

2. The method defined in claim 1, further comprising the steps of:
checking the subscriber database to determine whether the caller has subscribed to enhanced directory assistance service; and
checking the subscriber database to determine whether the service is active for the caller.

3. The method defined in claim 1, wherein the set of delivery options includes sending a short text message including the information to the mobile station of the caller, sending a voicemail message containing the information to the caller's voicemail system mailbox in a voicemail system, making a phone book entry containing the information on the mobile station, making an entry containing the information in the last numbers dialed list of the mobile station.

4. The method defined in claim 1, wherein the mobile station comprises one of a mobile telephone, a personal computer, or a handheld computing device.

5. The method defined in claim 1, further comprising the step of instructing a short message service center to transmit a text message containing the directory assistance information to the mobile station.

6. The method defined in claim 1, further comprising the steps of:
establishing a connection to the caller's voicemail system mailbox in a voicemail system; and
leaving a voice recording in the caller's voicemail system mailbox containing the directory assistance information.

7. The method defined in claim 1, further comprising the step of sending a message to the mobile station with instructions to add the directory assistance information to the mobile station's local phonebook.

8. The method defined in claim 1, further comprising the step of sending a message to the mobile station with instructions to add the directory assistance information to the mobile station's last number dialed list.

9. An apparatus for providing directory assistance to a caller having a mobile station, the apparatus comprising:
means for receiving a request for directory assistance from the caller;
means for obtaining directory assistance information from a database;
means for giving a set of delivery options for the directory assistance information to the caller;
means for determining whether the caller has chosen one or more delivery options from the set of options;
where the caller has chosen at least one delivery option, means for sending the directory assistance information to the caller via the delivery option or options chosen by the caller; and
where the caller has not chosen at least one delivery option, means for sending the directory assistance information to the caller via a default delivery option.

10. The apparatus defined in claim 9, further comprising:
means for checking the subscriber database to determine whether the caller has subscribed to enhanced directory assistance service; and
means for checking the subscriber database to determine whether the service is active.

11. The apparatus defined in claim 9, wherein the set of delivery options comprises a short text message including the information to the mobile station of the caller, a voicemail message containing the information sent to the voicemail system, a phone book entry containing the information on the mobile station, an entry containing the information in the last numbers dialed list of the mobile station.

12. The apparatus defined in claim 9, wherein the mobile station comprises one of a mobile telephone, a personal computer, or a handheld computing device.

13. The apparatus defined in claim 9, further comprising means for instructing a short message service center to transmit a text message containing the directory assistance information to the mobile station.

14. The apparatus defined in claim 9, further comprising:
means for establishing a connection to the caller's voicemail system mailbox in a voicemail system; and
means for leaving a voice recording in the caller's voicemail system mailbox containing the directory assistance information.

15. The apparatus defined in claim 9, further comprising means for sending a message to the mobile station with instructions to add the directory assistance information to the mobile station's local phonebook.

16. The apparatus defined in claim 9, further comprising means for sending a message to the mobile station with instructions to add the directory assistance information to the mobile station's last number dialed list.

17. In a wireless network, an apparatus for providing directory assistance to a wireless service subscriber having a mobile station, the apparatus comprising:
a directory assistance center operative to provide directory assistance information to the subscriber upon a request from the subscriber via the mobile station;
a switching element operative to route directory assistance information to the subscriber via a delivery method, the switching element including a data processor, tone detection circuitry, a text-to-speech system, and a directory assistance module;
a subscriber database containing subscriber profile information and mobility management information;
a voicemail system operative to allow callers to leave recorded messages for the subscriber when the subscriber is not available; and
a messaging center operative to send text messages to the subscriber via the mobile station.

18. The apparatus defined in claim 17, wherein the delivery method comprises a short text message including the information to the mobile station of the caller.

19. The apparatus defined in claim 17, wherein the delivery method comprises a voicemail message containing the information sent to the voicemail system.

20. The apparatus defined in claim 17, wherein the delivery method comprises a phone book entry containing the information on the mobile station.

21. The apparatus defined in claim 17, wherein the delivery method comprises an entry containing the information in a last numbers dialed list on the mobile station.
